(19) United States
(12) Patent Application Publication
(10) Pub. No.: US 2015/0068251 A1
(43) Pub. Date: Mar. 12, 2015

(54) Method for drawing glass strips

(71) Applicant: SCHOTT AG, Mainz (DE)

(72) Inventors: Clemens Ottermann, Hattersheim (DE); Frank Buellesfeld, Kriftel (DE); Ulrich Lange, Mainz (DE)

(21) Appl. No.: 14/474,364

(22) Filed: Sep. 2, 2014

(30) Foreign Application Priority Data
Aug. 30, 2013 (DE) 10 2013 109 443.0

(51) Int. Cl. C03B 23/037

(52) U.S. Cl. CPC C03B 23/037
USPC 65/106

(57) ABSTRACT

A method for producing a glass strip is provided. The method includes providing a glass preform with flat cross section, wherein the width of the cross section is at least five times greater than its thickness, wherein the cross section tapers into the edge regions in such a way that the thickness of the glass preform relative to its side edges amounts to at most two-thirds of the maximum thickness of a plate-shaped center region of the glass preform; heating the glass preform within a deformation zone, so that the glass found in the deformation zone softens; and applying a tensile force onto the glass preform in the direction perpendicular to the cross section, so that the glass preform is drawn in length in the deformation zone.

The invention, in general, relates to the production of flat glass strips. In particular, the invention relates to a method, with which the formation of thickened edge regions, which are also called edgings, can be controlled.

The re-drawing of glasses is known in principle; the method is particularly also used for the drawing of glass fibers.

In the re-drawing method, a piece of glass is partially heated and drawn in length via suitable mechanical equipment.

If the piece of glass—the preform—is conveyed at a constant rate into a heating zone and the heated glass is drawn at a constant rate, then the cross-sectional shape of the preform is reduced, a reduction that is dependent on the ratio of these rates. Thus, if tube-shaped preforms are utilized, for example, tube-shaped products are again formed, but with smaller diameter, of course. The products are similar in their cross-sectional shape to the preform; in fact it is desired most often to obtain a reduced image of the preform that is correct in scale by means of suitable measures. Such a method for producing cylinder-shaped components made of glass is known from EP 0 819 655 A2.

In the re-drawing of glasses, usually an elongated preform is clamped on one side in a holder and heated at the other end, for example, in a muffle furnace. As soon as the glass can be deformed, it is drawn out by introducing a tensile force on the end of the preform clamped in the holder. Therefore, if the preform is then moved again into the muffle, a product that is smaller in cross section, but is geometrically similar, results with a suitable selection of temperature.

For example, a glass fiber is drawn out from a preform having a round cross section. The selection of the rates of drawing out the product, for example, a component and, if needed, moving the preform again, determines the reduction factor of the cross section. Normally, the ratio of thickness to width of the cross section of the preform remains constant. This is desired when drawing glass fibers, since a glass fiber also having a round cross section can be drawn from a preform with a round cross section.

It is difficult to re-draw flat components, components having a ratio of width to thickness of the cross section of 80:1, for example. It is only possible to draw wide components from very wide preforms. Thus, a component having a cross section of 7 mm width and 1 mm thickness (w/th=7) can be produced, for example, from a preform with a cross section of 70-mm width and 10-mm thickness (W/TH=7).

A component having a wider cross section but the same thickness is only possible with the use of a preform having a wider or thinner cross section. The use of a wider preform often fails in in that it cannot be produced, and the use of a thinner preform becomes increasingly uneconomical, since the preform must be frequently alternated in the case of re-drawing.

Added to this is the fact that glass strips, in particular thin-glass strips, which are produced in drawing processes, generally have edgings on the two side edges. These edgings are strip regions, in which the glass is clearly thicker than inside the high-quality surface area having the provided target thickness. The edgings result from the surface tension of the glass in the melt and, in principle, represent a loss of usable glass. In some methods, for example, in the float process, the edgings are utilized for guiding and/or spreading the glass strip, but generally they have disadvantages and negative effects. A reduction in the high-quality width results. A corresponding loss in production also accompanies this, e.g., due to costs for energy and raw materials. The edgings also lead to stresses in the glass strip. These may introduce an undesired warp. Also, intrinsic stress fields may lead to losses in yield in further processing (rolling, cutting).

If the stresses that are increased by the edgings must be reduced, a longer cooling path must be provided or the drawing rate must be slowed down correspondingly. The plant costs or the manufacturing costs are increased in this way.

Edgings may be unstable in their expression over the production process, change their shape “statistically”, and thus lead to unstable processes.

Additionally, for thin glass on rolls, it happens that the thicker edgings influence the minimum radius of curvature and thus the design of the roll core, so that the glass strip must be wound onto clearly larger roll cores. This leads to an increased space requirement in the design of processing machines for the rolls as well as also for their storage.

A combination of heating and cooling of the edge region of the preforms during the hot forming in the re-drawing process is described in JP 58-95622 A. In a second, separate heating process, this edging region is heated more intensely than the central thin-glass region and then is locally cooled. This will reduce the edging thickness. Due to the greater temperature gradient between the edging region and the thin-glass high-quality zone used in this process, however, additional intrinsic stress components are induced here in the glass membrane, these stress components adversely affecting the further processing of the glass.

Thus, the object of the present invention is based on obtaining a reduction in the expression of the edgings, especially in the re-drawing process.

A minimizing or ideally an elimination of the above-named disadvantages can be achieved by a reduction in the expression of the edgings in the re-drawing process. In particular, by the reduction in the expression of the edgings:
the high-quality width will be increased;
the expression of intrinsic stresses will be reduced; and thus
a higher drawing rate (reduction in cost) will be made possible;
the glass loss will be reduced;
and the use of a smaller diameter of the roll core will be achieved without. increase in the bending stresses.

The object is achieved by the subject of claim 1. Advantageous embodiments and enhancements of the invention are indicated in the dependent claims.

Accordingly, the invention provides a method for producing a glass strip, with the steps:
providing a glass preform with flat cross section, wherein the width of the cross section is at least five times greater than its thickness, wherein the cross section tapers in the edge regions, or the thickness of the cross section decreases in such a way that the thickness of the glass preform relative to its side edges amounts to at most two-thirds, preferably at most one-half, of the maximum thickness of a plate-shaped center region of the glass preform;
heating the glass preform within a deformation zone, so that the glass found in the deformation zone softens;
applying a tensile force to the glass preform in the direction perpendicular to the cross section, so that the glass preform is drawn in length in the deformation zone, and from the glass preform, a glass strip with flat cross section is produced, whose width is at least five times greater than its thickness, and wherein the thickness of the glass strip is less than the thickness of the glass preform.

The special cross section provides for the fact that the thickness of the edging is considerably reduced. In this case, in addition, it is favorable that the time of action of the hydrodynamic forming of the glass edges is reduced due to surface tensions. If the time of action is too long, the effect brought about by the special cross-sectional shape in the formation of the cross section of the drawn glass strip might be lost. The thickness can be reduced at the edge so that an edge surface remains, whose height is less than the thickness of the glass preform. It is also possible, however, to bevel or to facet the edge region, so that an edge face is no longer present. The edges of the glass preform in this case have the configuration of a cutting edge.

In the sense of the invention, the deformation zone is understood to be that part of the preform in which the preform has a thickness between 0.95 times the thickness TH of the glass preform (0.95*TH) and 1.05 times the thickness th of the glass strip (1.05*th). In other words, the deformation zone also represents the region in which a meniscus is formed between the preform and the drawn glass strip. The deformation zone preferably extends over the entire width of the preform.

In the deformation zone, the glass is preferably brought to a temperature T2 sufficient for softening the glass. At this temperature, the viscosity is 10⁸ dPas at most, more preferably 10^{7.6} dPas at most. A suitable viscosity range lies between 10⁴ dPas and 10⁸ dPas. In preferred embodiments, the glass in the deformation zone is heated to a temperature T2, which corresponds to a viscosity of the glass of the preform of 10^{5.8} dPas to 10^{7.6} dPas.

It has been demonstrated as favorable if the deformation zone has a length in the drawing direction that is shorter than the width of the glass preform. The reduction in cross section consequently occurs only along a short lengthwise segment. It is surprising here that the short deformation zone and thus the great change in cross section occurring in the drawing direction in the deformation zone does not negatively affect the shape of the glass strip. In an enhancement of the invention, in fact, deformation zones are preferred, which at most are half as long in the drawing direction as the width of the glass preform, more preferably in which the length is at most one-third of the width of the glass preform.

Particularly preferred, however, the deformation zone is designed on the basis of the thickness of the glass preform. In an enhancement of the invention, independent of the width of the preform, the glass is heated in such a way that the deformation zone has a length in the drawing direction of at most 6*TH, thus six times the thickness of the glass preform at most, preferably 5*TH at most, and particularly preferred, 4*TH at most.

Typical lengths of the deformation zone in the drawing direction, depending on the thickness of the glass preform, are preferably 100 mm at most, particularly 40 mm at most, and particularly preferred 30 mm at most.

The invention will be explained below more precisely on the basis of the appended drawings and on the basis of the examples of embodiment. Here, the same reference numbers in the drawings refer to the same or corresponding elements in each case. Herein:

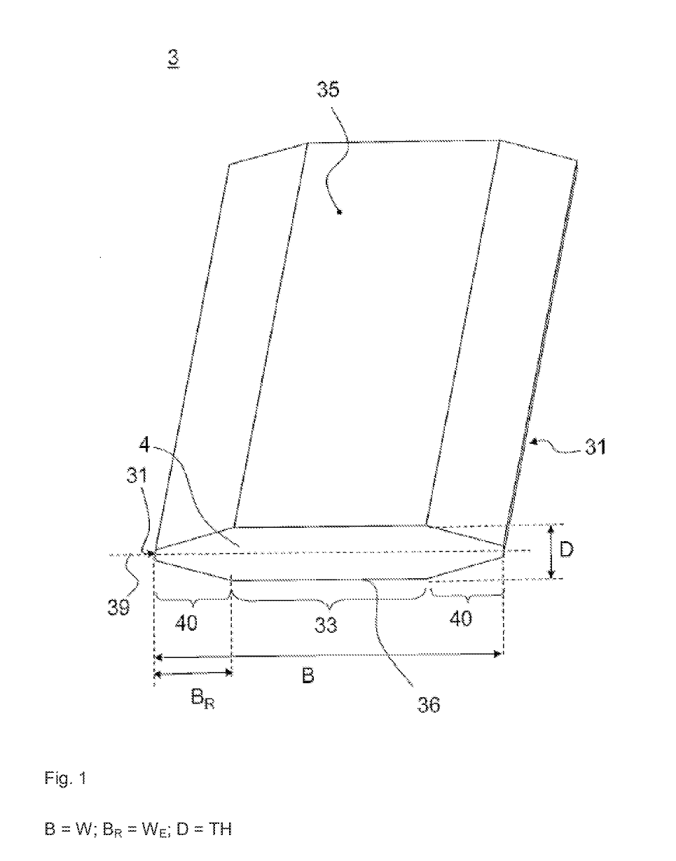

FIG. 1 shows schematically a glass preform;

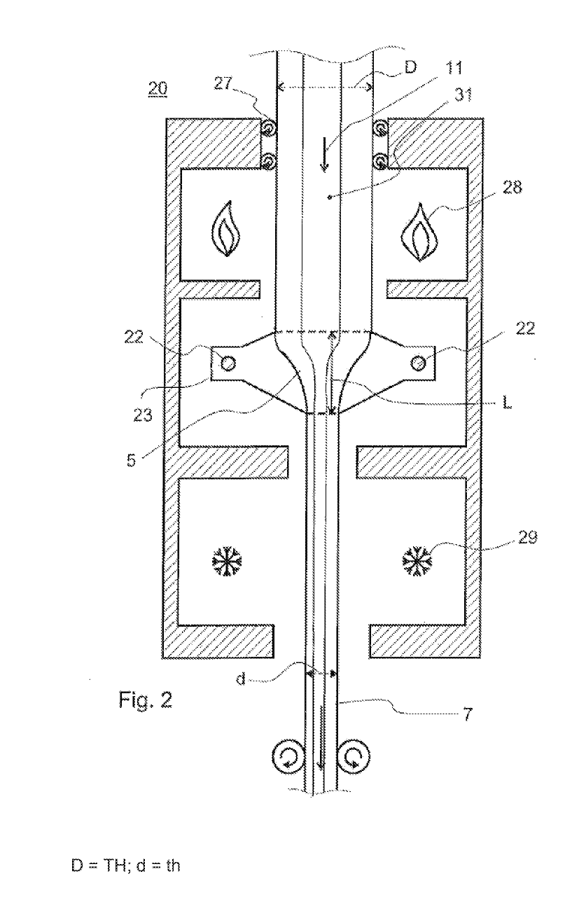

FIG. 2 shows a device for conducting the method;

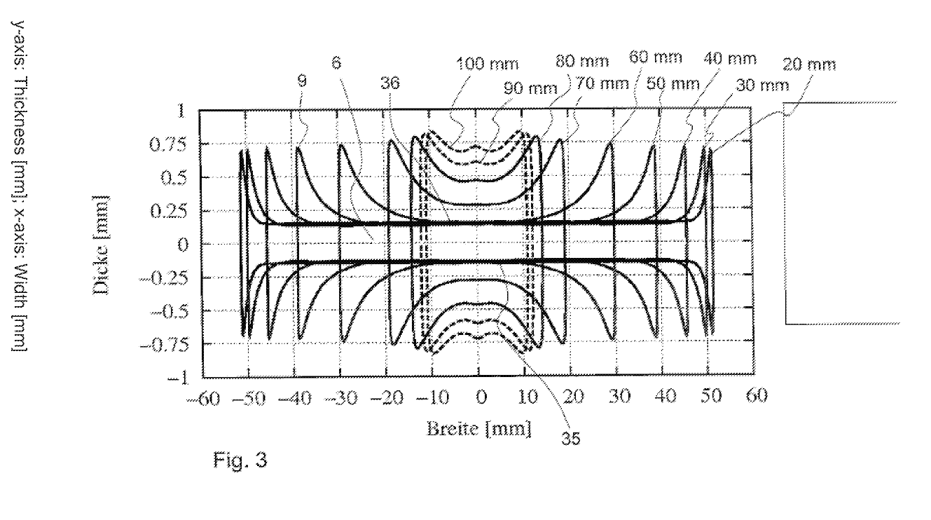

FIG. 3 shows cross sections of glass strips dependent on the length of the deformation zone;

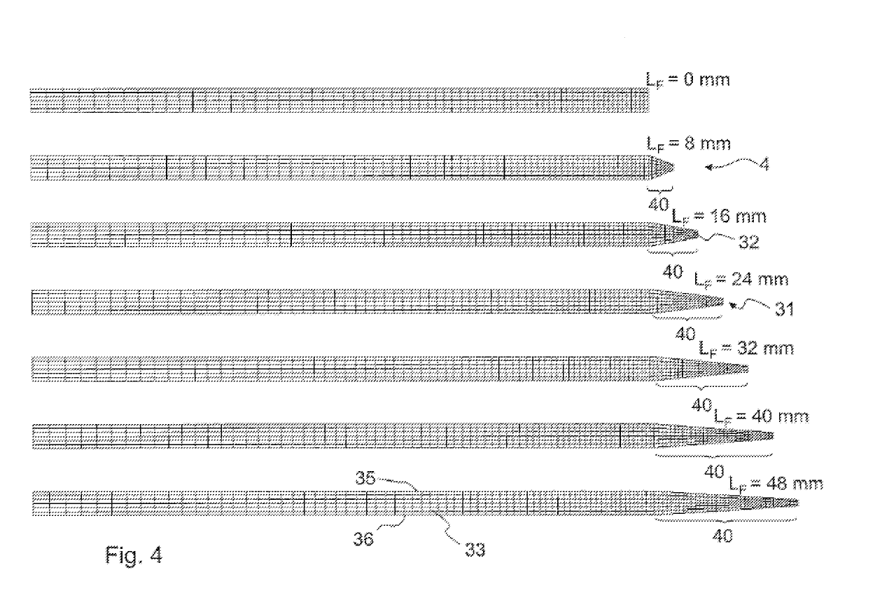

FIG. 4 shows halved cross sections of 8-mm thick preforms with edge regions of differing width;

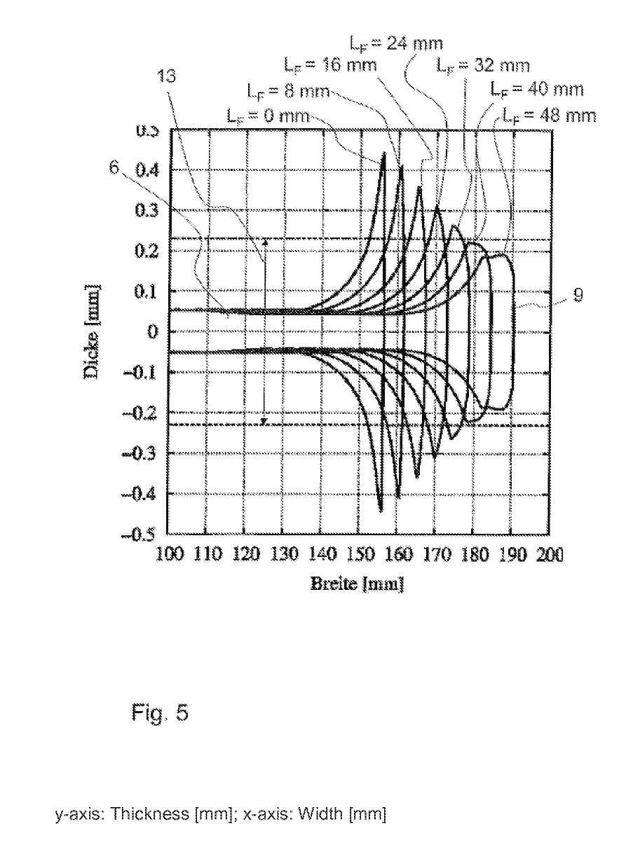

FIG. 5 shows cross sections of glass strips produced from the preforms shown in FIG. 4;

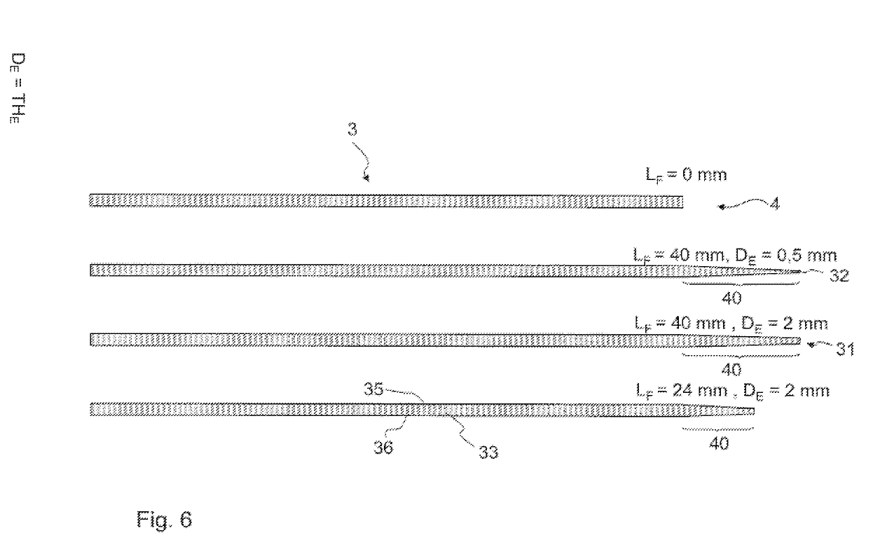

FIG. 6 shows halved cross sections of 4-mm thick preforms with edge regions of differing width;

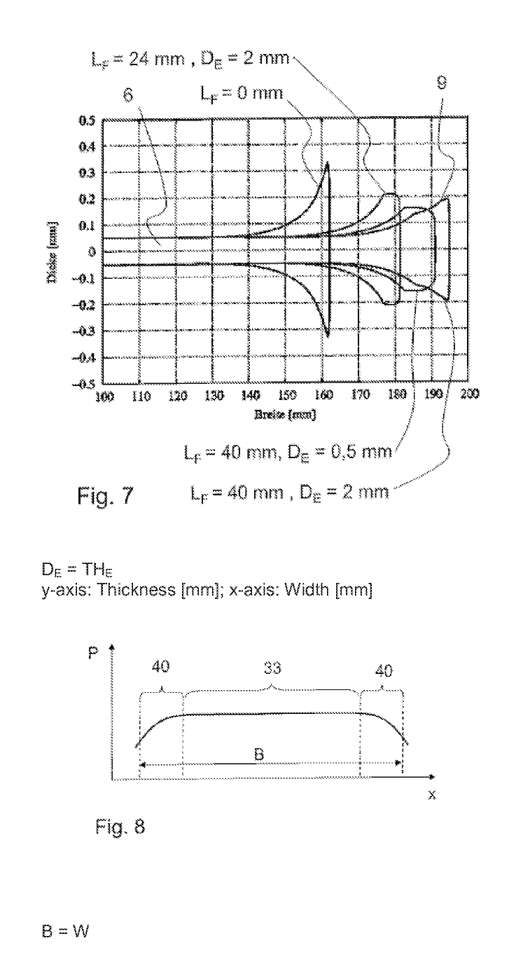

FIG. 7 shows cross sections of glass strips produced from the preforms shown in FIG. 6;

FIG. 8 shows a curve of the heating power over the width of the glass preform; and

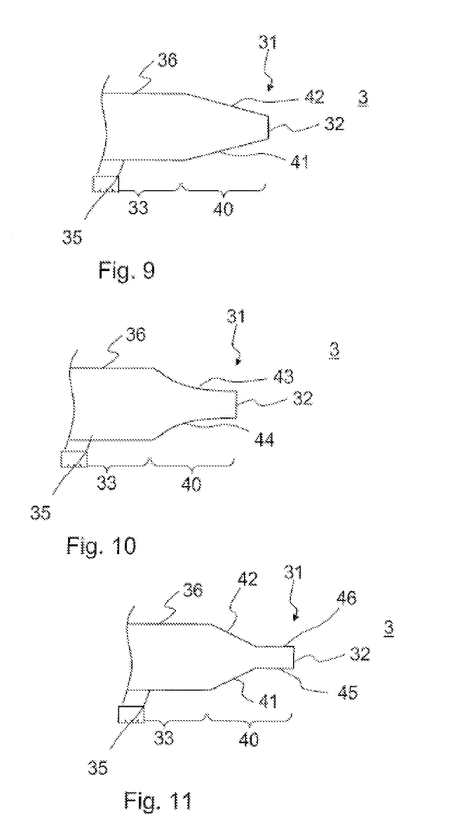

FIGS. 9 to 14 show embodiments of the shaping of the edge regions.

An example of embodiment of a glass preform 3 according to the invention is shown in FIG. 1. The glass preform 3 has a flat cross section 4; thus in general, it has a plate-shaped or disk-shaped configuration. In particular, the width W of the cross section 4 is at least five times greater than its thickness TH.

As can be recognized based on FIG. 1, the glass preform has edge regions 40, in which the cross section tapers, or in which the thickness of the respective side edge 31 tapers. The thickness of the side edge 31 amounts to at most ⅔ of the thickness TH in the plate-shaped center region 33, in which the two surfaces 35, 36 lying on opposite sides of the glass preform 3 run parallel.

In order to reduce the formation of edgings in the glass strip drawn from the glass preform 3, it is favorable, in addition, if the edge regions 40 have a sufficient width. Without limitation to the example especially shown in FIG. 1, it is particularly favorable if the width W_{E} of the edge regions in which the cross section 4 tapers or the thickness of the cross section decreases, is at least as large as the thickness TH of the glass preform 3.

In order to avoid stresses in the drawn glass strip, in addition, it is generally favorable if the cross section is shaped mirror-symmetrically to the center plane 39 between the surfaces 35, 36 on the two sides, as is also shown in the example of FIG. 1. In this way, the edging is also mirror-symmetrical, so that possible stresses are compensated for as much as possible.

The length L of the preform in the drawing direction preferably amounts to at least 500 mm, preferably at least 1000 mm. It is generally true that the method can be operated more economically, the longer the preform is. Therefore, even longer preforms are also conceivable and advantageous.

In addition, preferably L>W; thus, the glass preform has a length in the drawing direction that is longer than the width of the cross section.

FIG. 2 shows a drawing device 20 for conducting the method according to the invention. The glass preform 3 is shown here from the side in a view onto the edges 31.

For example, the glass preform 3 is moved from top to bottom through the drawing device 20. The drawing device 20 has two heating means 22, which are disposed in a central region of the device 20. In this embodiment, the heating means 22 are shielded with screens 23, so that a deformation zone 5 is formed. A portion of the glass preform 3, which is found in the deformation zone 5, is heated in such a way that it reaches a temperature T2, in which the viscosity of the glass lies below 10⁸ dPas, preferably at most 10^{7.6} dPas. The deformation zone 5 has a length L in the drawing direction 11. The glass preform 3 is drawn in the drawing direction 11, for example downward, by a drawing means 26, which is executed here in the form of two driven rollers. Due to the fact that a feeding means 27, here also configured in the form of ropers, feeds the glass preform 3 more slowly than the drawing means 26 draws it, the glass preform 3 is deformed in the deformation zone 5. In this way, the glass preform 3 becomes thinner; after the deformation, the thickness th of the thus-formed glass strip 7 is less than the thickness TH prior to the deformation.

In general, and without limitation to the special example of a drawing device 20 that is shown in FIG. 2, the glass preform is preferably already preheated prior to heating in the deformation zone 5. For this purpose, the drawing device 20 preferably has a pre-heating zone, in which the preform can be heated to a temperature T1. The preheating zone is preferably disposed in a region arranged upstream to the deformation zone, as viewed in the drawing direction 11, for example, in an upper region of the drawing device 20. The temperature T1 preferably corresponds to a viscosity η1 of 10¹⁰ to 10¹⁴ dPas. The glass preform 3 is thus preferably preheated prior to input into the deformation zone. In this way, a more rapid movement through the deformation zone 5 is possible, since the time that is required in order to reach the temperature T2 for softening the glass is shorter. Also, due to the preheating zone, one avoids shattering glasses with high temperature expansion coefficients due to temperature gradients that are too great. Without limitation to this example of embodiment, the temperature T2 is generally selected so that the glass softens, thus so that the viscosity of the glass has a value of 10⁸ dPas at most, more preferably 10^{7.6} dPas at most.

Before the glass of the glass preform 3 is introduced into the deformation zone 5, it is thus preheated to a temperature T1 by means of a preheating means 28, symbolized here by a burner flame in the example shown in FIG. 2.

After passing through the deformation zone 5, the preform 1 is introduced into a cooling means 29, which is symbolized here by an ice crystal. The glass is preferably slowly cooled under this means in a controlled manner in order to decompose stresses. Actually, the cooling means 29 can thus be formed as a cooling or annealing oven, in which the glass passes through the viscosity region between upper and lower cooling points in the annealing oven.

The method according to the invention may also be operated with a glass preform 3, which is wound onto a first roll. In this case, the glass preform 3 is attached so that it can be unwound from the roll. The free end of the glass preform 3 is then drawn from the roll by means of the drawing means and/or the feeding means. The glass preform 3 is then preferably drawn continuously and uniformly through the deformation region containing the heating means 22, so that a deformation zone 5 is formed in the preform. After passing through the drawing device 20, the thus-produced glass strip is preferably wound up onto a second roll.

By providing the preform on a roll and/or winding up the flat glass strip 7 onto a roll, the method can be conducted economically overall, since the glass preforms do not need to be introduced individually into the device.

Glass components can subsequently be detached, for example, by cutting the glass strip 7. Further, the somewhat thickened edge regions (edgings) of the glass component can also be separated. Insofar as it is necessary, the glass component can also still be polished and/or coated. The method according to the invention makes it possible to obtain glass components that have a very large usable glass surface. This means that the proportion of the glass component that has the necessary quality is very high. The proportion of the surface having edgings that must be removed, if necessary, prior to use is small in the method of this invention. The glass components that can be separated from the glass strip 7 preferably have a thickness-width ratio of 1:2 to 1:20,000.

Now, in order to avoid the formation of thick edgings in the drawing of the glass strip, according to the invention, the thickness of the glass preform is reduced in the edge regions. Of course, it has turned out that hydrothermodynamic processes and the surface tension of the softened glass counteract the effect obtained due to the tapering of the cross section on the edge side. The design of the glass preform according to the invention is thus preferably combined with a short heating zone and correspondingly with a short deformation zone 5 for mutual interaction. In this way, the edging can no longer be significantly influenced by the geometry of the glass preform.

FIG. 3 also shows the effect of the length of the deformation zone 5 in the drawing direction. In this diagram, cross sections 6 of the drawn glass strips 7 are shown. The length of a heating muffle as the heating means is given in millimeters for each of the cross sections 6. The length of the heating muffle approximately reproduces the length of the deformation zone 5. The glass preforms used in this example, of course, do not have a tapering of the cross section in the edge regions according to the invention. The cross sections of the preforms are therefore rectangular. In fact, the thickness of the edgings 9 changes only slightly; of course, a long deformation zone leads to a constriction and thus to a reduction in the width of the cross section. In the case of long heating zones or muffles from 70 mm to 100 mm length in the drawing direction, the glass is also thicker in the center region between the edgings 9. Therefore, of course, the relative difference in thickness between edging and center region also decreases. Thus the glass strip drawn with the longest heating muffle (100-mm length in the drawing direction) comes the closest by its geometry to the rectangular initial geometry of the glass preform (the different scale of the two axes is also to be noted here). This is a crucial reason why previously very long deformation zones, or correspondingly long heating zones were used in drawing devices. It is clear, however, based on the cross sections of the glass strips produced with shorter deformation zones, that these have a better parallelism of the surfaces 35, 36 on either side in the center region.

It can also be seen that the shrinking of the width of the glass strip 7 relative to the width of the glass preform 3 decreases with a decrease in the length of the deformation zone. In general, and without limitation to the example of embodiment in FIG. 3, in an enhancement of the invention, it is thus provided that the width w of the glass strip 7 that is produced is preferably barely reduced relative to the width W of the glass preform 3. This means that the glass strip 7 is drawn so that the ratio W/w of the width W of the cross section 4 of the glass preform 3 to the width of the cross section 6 of the drawn glass strip 7 is 2 at most, preferably 1.6 at most, and more preferably 1.25 at most.

FIG. 4 shows cross sections 4 of glass preforms with edge regions 40 of different width. In each case, only half of the cross sections 4 are shown. The width L_{F} of the edge region 40, in which the cross section or the thickness tapers relative to the side edge 31, is indicated each time above the cross section. The cross section 4 shown at the top, which is not according to the invention, has no tapering edge region 40 and is thus rectangular. The remaining cross sections are facetted at the side edge 31, so that an edge region 40 results with decreasing thickness relative to the side edge 31. The thickness of the glass preforms of this example in each case amounts to 8 mm. The edges are facetted so that an edge surface 32 with a height of 2 millimeters remains.

Accordingly, for all glass preforms except for the uppermost preform with L_{F}=0 mm, it is valid that the thickness at the side edge 31, or here the height of the edge surface 32 amounts to less than one-half (namely one-fourth) of the maximum thickness of the plate-shaped center region 33 of the glass preform 3.

It is also valid for all preforms except for the top one that the width of the edge regions 40 in which the cross section 4 tapers is at least as great as the thickness TH of the glass preform 3. For the second preform from the top with L_{F}=8 mm, the width of the edge region 40 is exactly the same as the thickness of the glass preform.

FIG. 5 shows the cross sections 6 of the glass strips 7 drawn from the glass preforms according to FIG. 4. Again, only edge-side excerpts of the cross sections 6 are shown. The cross sections were calculated by means of a simulation. The simulation was based on the following parameters: The glass strips were produced in a 40-mm long heating muffle having a discharge rate of 1000 millimeters per minute, whereby the glass strip was drawn to a thickness of 100 micrometers.

All glass strips, or correspondingly also their cross sections 6 show edgings 9, which are represented as a thickening at the edge of the glass strip.

In the case of the preform without faceting of the edge (L_{F}=0 mm), an edging results with a height of approximately 0.9 millimeters. The preforms according to the invention, in contrast, show a smaller height of the edgings than the glass preform not according to the invention with rectangular cross section and L_{F}=0 mm. Even in the case of the glass preform with L_{F}=8 mm, in which the width of the edge region 40 is thus just the same as the thickness of the preform, a reduction of the edging height from 0.9 mm to approximately 0.8 mm is already observed, when compared to the preform with rectangular cross section. Since the stiffness of an object increases with the cube of the thickness, in this case, a clearly more flexible glass strip also results, which, among other things, makes possible rolling it up onto a smaller roll core.

An arrow 13 is also depicted. This arrow characterizes the edging height that results if a glass preform not according to the invention, without cross section tapering in the edge region, but rather having a thickness of only two millimeters is used, and a glass strip also having a thickness of 100 micrometers is drawn. In the case of a width of the edge region of 32 millimeters, the edging height is already of similar size; in the case of glass preforms with widths of the edge region starting from 40 millimeters, the edging height is in fact smaller. Edge regions that are longer than the thickness of the glass preform are thus more effective with respect to suppressing edging heights. Therefore, it is generally preferred to use a glass preform 3, for which the edge regions 40, in which the thickness of the glass preform is reduced toward the edge, are in each case at least three times, preferably at least four times as wide as the thickness of the glass preform.

As can be seen based on the example of embodiment of FIG. 5, in addition, the invention also facilitates the drawing of glass strips that have a considerably reduced thickness when compared to the glass preform 3. In the example of embodiment shown, the thickness th of the glass strip 7 amounts to only 1/80th the thickness of the preform.

In general, it is preferred that the glass strip is drawn enough that its thickness th preferably amounts to at most one-tenth, preferably at most one-thirtieth, and more preferably at most one-fiftieth the thickness of the glass preform 3. This can be combined in a particularly advantageous way also with the above-named small reduction in the width of the glass strip when compared with the width of the glass preform.

According to another embodiment of the invention, the glass strip has a thickness th preferably of less than 300 micrometers, more preferably of less than 200 μm, and even more preferably of less than 150 μm. It is also possible to draw glass strips with a thickness of 50 μm and less.

It is also possible with the invention to clearly increase the width-to-thickness ratio of the glass preform (W/TH) in comparison to the width-to-thickness ratio of the glass strip (w/th).

In general, and without limitation to the embodiment examples, according to one embodiment of the invention, a flat glass strip 7 with a width w and a thickness th is drawn from a glass preform with a width W and a thickness TH, the ratio w/th being essentially larger than the ratio W/TH. In general, and without limitation to the embodiment examples, with the shaping of the cross section of the glass preform according to the invention and the preferred short heating zone with the enlargement of the aspect ratio of length to width of the glass preform 3, the glass strip 7 can be drawn so that the ratio of length to width of the cross section 6 of the glass strip is at least twenty times greater than the ratio of length to width of the cross section 4 of the glass preform 3.

Additional embodiment examples of the glass preforms according to the invention and glass strips produced therefrom will be explained on the basis of FIG. 6 and FIG. 7.

Only half of the glass preforms 3 are shown again in FIG. 6, as they were also depicted in FIG. 4. Unlike the example of embodiment of FIG. 4, the thickness of the glass preforms here, however, amounts to only 4 mm. In the uppermost glass preform 3, an edge region with tapering cross section is not present. Therefore, it does not involve a glass preform for conducting the method according to the invention. The two middle glass preforms 3 each have an edge region 40 with a width L_{F} of 40 mm. In the lowermost glass preform 3, a short edge region with a length of L_{F}=24 mm is provided. In the case of the glass preforms according to the invention, the thickness TH_{E} at the side edge 31 is given, in addition to the width L_{F} of the edge region 40. In the case of the second glass preform from the top, the thickness TH_{E} amounts to 0.5 mm; the two lower glass preforms have a thickness TH_{E} of 2 mm, as in the embodiment example of FIG. 4. Accordingly, it is true for all these latter glass preforms that the cross section 4 tapers in the edge region 40 in such a way that the thickness of the glass preform 3 is at most two-thirds at its side edge 31. In particular, in the case of the two lower preforms, the thickness amounts to one-half the maximum thickness of the plate-shaped center region 33 of the glass preform 3; in the case of the second glass preform from the top, the thickness TH_{E} amounts to only one-eighth of the maximum thickness in the center region 33 or the thickness of the preform in general.

Based on FIG. 7, it can be seen that a clear reduction in the height of the edgings 9 is achieved in the case of all glass preforms according to the invention. According to FIG. 6, all glass preforms 3 according to the invention also fulfill the preferred characteristic that the tapering edge regions 40 are at least three times, preferably at least four times wider than the thickness of the glass preform 3, or the maximum thickness of the plate-shaped center region 33. In particular, in the case of the glass preform 3 with L_{F}=24 mm, the edge region is six times wider than the thickness in the center region. In the case of the two glass preforms with L_{F}=40 mm, the edge region is in fact ten times wider.

The lowest height of the edging 9 is achieved in the case of the glass preform with the smallest thickness (0.5 mm) at the side edge 31. Therefore, it is also advantageous to reduce as much as possible the thickness at the side edge. Of course, with a geometry more and more approaching a cutting edge, the risk also increases that defects will be introduced at the side edge. Generally, it is provided in an enhancement of the invention that the thickness at the side edge still amounts to at least one-tenth of the thickness in the plate-shaped center region, or the thickness of the glass preform 3.

In addition, the above-described embodiment examples are now based on the fact that a homogeneous temperature profile exists in the deformation zone 5 in the direction perpendicular to the drawing direction 11. Of course, a rapid heating of the glass also accompanies this in the case of the short deformation zone, which has a length of at most six times the thickness of the glass preform in an enhancement of the invention. It may happen now here for this purpose that the edge regions 40 heat up more rapidly and/or to a higher temperature than the plate-shaped center region 33 due to the lesser thickness of the glass. The lower viscosity in the edge region 40, which is associated therewith, due to the surface tension of the glass, can then lead to the fact that the effect of compensating for the formation of edgings will be partially undone. In an enhancement of the invention, it is thus provided that the glass, or the glass preform 3—preferably in the deformation zone 5—is heated with a heating means that exercises a lower heating power on the glass in the edge regions 40 than in the plate-shaped center region.

For this purpose, FIG. 8 shows schematically as a diagram the heating power P of a heating means over the width W of the glass preform 3. The decreasing heating power in the edge regions 40 can be produced not only by the heating means 22 for softening the glass in the deformation zone 5, but optionally also by the preheating device 28.

Embodiments for the shaping of the cross section of glass preforms 3 suitable for the invention are described below. In the following figures, in each case, only a portion of the glass preform with one of the edge regions 40 is shown.

FIG. 9 shows an embodiment that is based also on the previously described embodiment examples. The edge region 40 has two beveled surfaces 41, 42. Accordingly, the cross section or the thickness tapers continually and linearly to the side edge 31. The side edge 31 is formed by an edge face 32. This shape of the cross section can be formed in a simple way, for example, by grinding the beveled surfaces 41, 42. The height of the edge face 32 according to the invention amounts to at most ⅔rd the thickness of the glass preform 3 in the plate-shaped center region 33.

FIG. 10 shows a variant of the embodiment shown in FIG. 9. In this variant, there are concave surfaces 43, 44 instead of the planar beveled surfaces 41, 42. Such a shaping can bring about a further compensation for the formation of edgings.

FIG. 11 shows a simplified enhancement of the embodiment shown in FIG. 10. Here, the concave surfaces 43, 44 are approximated by two beveled surfaces 41, 42 to which are connected two parallel surfaces 45, 46. The edge face 32 is connected to the two surfaces that are parallel to one another.

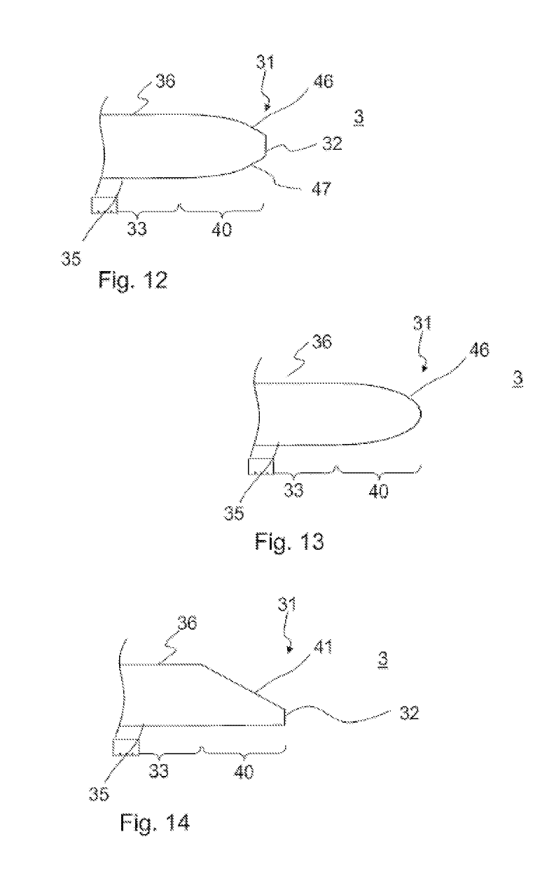

FIG. 12 shows an embodiment in which the tapering of the cross section in the edge region 4 is provided by two convex surfaces 46, 47 running toward one another to the side edge 31. A generally convex shape of the edge region is advantageous in order to reduce constrictions next to edgings 9. Such a constriction can be recognized, for example, in FIG. 5 in the cross section of the glass strip that was drawn from the glass preform with L_{F}=48 mm. Here, the thickness of the glass strip next to the edging 9 with a width coordinate of 160 mm is somewhat smaller than the glass thickness further centrally, at approximately 100 mm. A convex shape is thus favorable for enlarging the useful width of the drawn glass strip 7.

FIG. 13 shows a variant, in which a convex form of the edge regions is also present, the side edge 31 also being shaped convex. The side edge 31 is thus rounded and a planar face 32 is not present. The edge region 40 here is accordingly formed by a single convex surface 46.

All of the previously shown edge regions, as is also the case for the example shown in FIG. 1, were mirror-symmetrical to the center plane between the two surfaces 35, 36 lying on opposite sides. This is advantageous in order to also form a mirror-symmetrical edging 9. FIG. 14 now shows an example, in which the tapering of the cross section in the edge region 40 is not mirror-symmetrical. In particular, here only a single beveled surface 41 or facet is provided, which extends from the surface 36 on one side, and obliquely to this surface, runs down to the edge face 32. In general, and without limitation to the example of embodiment, according to yet another embodiment of the invention, a one-sided tapering of the cross section is thus provided in the edge region 40, whereby the surface on one side (the surface 35 in the example) continues running in a straight line into the edge region 40.

Such an embodiment of the invention is thus first of all advantageous, since the production of the edge region 40 is simplified. For example, equipment for the faceting of mirrors can be used for this purpose. Another advantage results, since the asymmetry of the edge region 40 can now also directly equilibrate an asymmetry in the temperature distribution between the surfaces on the two sides in the deformation zone 5. Conversely, an asymmetric heating can also be used optionally in a simple way, in order to again obtain a symmetrical edging 9.

It is apparent to the person skilled in the art that the invention is not limited to the exemplary embodiments described in the figures. Rather, the invention can be varied in multiple ways within the scope of the patent claims. In particular, the embodiment examples may also be combined with one another. Thus, for example, the asymmetric profile according to FIG. 14 can be modified by the surface shapes of the edge regions of FIG. 10 to FIG. 13. For example, the beveled surface 41 can be replaced by a convex surface 43, an approximation of a convex surface by two or more beveled surfaces, a convex surface 46 with edge face 32, or a convex surface extending up to the surface 35 on one side.

### LIST OF REFERENCE NUMBERS

Glass preform 3
Cross section of 3 4
Deformation zone 5
Cross section of 7 6
Glass strip 7
Edging 9
Drawing direction 11
Edging thickness for a 2-mm thick glass preform 13
Drawing device 20
Heating means 22
Screen 23
Drawing means 26
Feeding means 27
Side edge 31
Edge face 32
Center region of 3 33
Surfaces on the two opposite-lying sides 35, 36
Edge region 40
Beveled surfaces 41, 42
Concave surfaces 43, 44
Parallel surfaces 45, 46
Convex surfaces 46, 47

1-11. (canceled)

12. A method for producing a glass strip, comprising:
providing a glass preform with a flat cross section, the flat cross section having a width and a maximum thickness, the width being at least five times greater than the maximum thickness, the flat cross section having a plate-shaped center region that tapers to edge regions, the plate-shaped center region having the maximum thickness and the edge regions having a minimum thickness, the minimum thickness being at most two-thirds of the maximum thickness;
heating the glass preform within a deformation zone so that a region of the glass preform found in the deformation zone softens; and
applying a tensile force onto the glass preform in a direction perpendicular to the flat cross section so that the glass preform is drawn in length in the deformation zone to produce the glass strip with a strip width and a strip thickness, the strip width being at least five times greater than the strip thickness, the strip thickness being less than the maximum thickness of the glass preform.

13. The method according to claim 12, wherein the minimum thickness is at most one-half of the maximum thickness.

14. The method according to claim 12, wherein the deformation zone has a length in a drawing direction that is shorter than the width of the glass preform.

15. The method according to claim 12, wherein the region of the glass preform found in the deformation zone has a length in a drawing direction that is at most to six times the maximum thickness of the glass preform.

16. The method according to claim 12, wherein the edge regions have a width that is at least as large as the maximum thickness.

17. The method according to claim 12, wherein the minimum thickness is at least one-tenth of the maximum thickness.

18. The method according to claim 12, wherein the edge regions have a width that is at least three times the maximum thickness.

19. The method according to claim 12, wherein the edge regions have a width that is at least four times the maximum thickness.

20. The method according to claim 12, wherein the region of the glass preform found in the deformation zone heated to a viscosity of at most 10^{7.6} dPas.

21. The method according to claim 12, wherein the glass strip has a ratio of a width of the flat cross section to the strip width of at most 2.

22. The method according to claim 12, wherein the glass strip has a ratio of a width of the flat cross section to the strip width of at most 1.6.

23. The method according to claim 12, wherein the glass strip has a ratio of a width of the flat cross section to the strip width of at most 1.25.

24. The method according to claim 12, wherein the strip thickness is at most one-tenth of the maximum thickness.

25. The method according to claim 12, wherein the strip thickness is at most one-thirtieth of the maximum thickness.

26. The method according to claim 12, wherein the strip thickness is at most one-fiftieth of the maximum thickness.

27. The method according to claim 12, wherein the glass strip has a ratio of length-to-width of that is at least twenty times greater than a ratio of length-to-width of the flat cross section of the glass preform.

28. The method according to claim 12, wherein the step of heating the glass preform comprises heating with a lower heating power at the edge regions than in the plate-shaped center region.
